(19) United States
(12) Patent Application Publication
(10) Pub. No.: US 2011/0272390 A1
(43) Pub. Date: Nov. 10, 2011

(54) ENERGY SAVING FOOD FINISHING APPLIANCE AND METHOD

(75) Inventors: Douglas S. Jones, New Port Richey, FL (US); Joseph R. Knauss, Boca Raton, FL (US)

(73) Assignee: ENODIS CORPORATION

(21) Appl. No.: 13/095,850

(22) Filed: Apr. 27, 2011

Related U.S. Application Data
(60) Provisional application No. 61/332,467, filed on May 7, 2010.

(51) Int. Cl. H05B 1/00; F24C 3/08

(52) U.S. Cl. 219/201; 126/39 R

(57) ABSTRACT

A new style commercial salamander/cheese melter that will normally be off until product is placed under a gas burner, a heating time is selected and a start button is pressed. The burner lights, heats to infrared within 5 seconds (fast heat up), melts cheese or finishes a dish quickly, and then shuts off completely when a timing cycle has expired, freeing up the operator to do other activities and preventing over cooking of the product being finished.

### RELATED APPLICATION

This application claims the benefit of U.S. Provisional Patent Application Ser. No. 61/332,467, filed on May 7, 2010, the entire contents of which are incorporated herein.

### FIELD OF THE DISCLOSURE

This disclosure relates to a food finishing appliance that provides a finish to a food product, e.g., by melting, browning a surface or toasting the food product.

### BACKGROUND OF THE DISCLOSURE

In restaurants, current food finishing appliances, such as commercial cheesemelters/salamander broilers, are turned on at the beginning of the day and left on throughout the day operating at a minimum or a low fired setting. When a food product is placed under the burner for finishing, the operator must turn the heat control from low to high. The operator also must watch the food product during finishing making sure it is not overdone. When the finishing is done, the operator then must remove the food and turn the heat setting from high to low. The disadvantages of the current food finishing appliances are that the appliance must be left on all day so as to be ready to use without a long heat-up time, thereby consuming energy and expelling heat into the kitchen.

There is a need for a food finishing appliance and method that address the disadvantages of the current food finishing appliances.

### SUMMARY OF THE DISCLOSURE

The food finishing appliance of the present disclosure overcomes the aforementioned problems with an instant on burner that is turned on for a timed interval during which the food product is finished and then automatically turns off.

An embodiment of a food finishing appliance of the present disclosure comprises a food finishing cavity comprising an opening through which the food product to be finished is inserted and removed. An infrared gas heater is disposed within the food finishing cavity. A control circuit turns on the infrared gas heater and starts a finishing time interval and turns the infrared gas heater off when the finishing time interval ends. The infrared gas heater consumes energy only during the finishing time interval.

In another embodiment of a food finishing appliance of the present disclosure a control panel includes a finishing time interval selector that selects the finishing time interval and a start button that provides electrical energy to turn on the infrared gas heater and start the finishing time interval.

In another embodiment of a food finishing appliance of the present disclosure the control circuit connects and disconnects the infrared gas heater to one or more sources of energy as the finishing time interval starts and ends, respectively, so that the infrared gas heater consumes energy only during the finishing time interval.

In another embodiment of a food finishing appliance of the present disclosure the energy is a member of the group consisting of: gas and gas and electrical.

In another embodiment of a food finishing appliance of the present disclosure the infrared gas heater comprises an infrared gas burner that comprises a metal fiber mat within which combustion takes place.

In another embodiment of a food finishing appliance of the present disclosure the infrared gas burner further comprises a plenum that is in fluid communication with the metal fiber mat.

In another embodiment of a food finishing appliance of the present disclosure the plenum comprises a surface with a plurality of apertures to provide the fluid communication with the metal fiber mat.

In another embodiment of a food finishing appliance of the present disclosure the metal fiber mat comprises a surface of the plenum.

In another embodiment of a food finishing appliance of the present disclosure the food finishing cavity comprises a first food finishing area in which the opening and the infrared gas heater are disposed and a second food finishing area separate from the first food finishing area. The food finishing appliance further comprises an additional opening, an additional infrared gas heater is disposed in the second food finishing area, and an additional control circuit controls the finishing of an additional food product in the second area.

An embodiment of a method of the present disclosure comprises:

providing a food finishing cavity comprising an opening through which the food product to be finished is inserted and removed;

disposing an infrared gas heater within the food finishing cavity; and

providing a control circuit that turns on the infrared gas heater and starts a finishing time interval and turns the infrared gas heater off when the finishing time interval ends, wherein the infrared gas heater consumes energy only during the finishing time interval.

Another embodiment of the method of the present disclosure further provides a control panel that includes a finishing time interval selector that selects the finishing time interval and a start button that provides electrical energy to turn on the infrared gas heater and start the finishing time interval.

In another embodiment of the method of the present disclosure the control circuit connects and disconnects the infrared gas heater to one or more sources of energy as the finishing time interval starts and ends, respectively, so that the infrared gas heater consumes energy only during the finishing time interval.

In another embodiment of the method of the present disclosure the energy is a member of the group consisting of: gas and gas and electrical.

In another embodiment of the method of the present disclosure the heater comprises an infrared gas burner that comprises a metal fiber mat within which combustion takes place.

In another embodiment of the method of the present disclosure the infrared gas burner further comprises a plenum that is in fluid communication with the metal fiber mat.

In another embodiment of the method of the present disclosure the plenum comprises a surface with a plurality of apertures to provide the fluid communication with the metal fiber mat.

In another embodiment of the method of the present disclosure the metal fiber mat comprises a surface of the plenum.

In another embodiment of the method of the present disclosure the food finishing cavity comprises a first food finishing area in which the opening and the infrared gas heater are disposed and a second food finishing area separate from the first food finishing area. The food finishing appliance further comprises an additional opening, an additional infrared gas heater is disposed in the second food finishing area, and an additional control circuit controls the finishing of an additional food product in the second area.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a lower left perspective view of a food finishing appliance of the present disclosure;

FIG. 2 is a lower right perspective view of the food finishing appliance of FIG. 1;

FIG. 3 is a front perspective view of the food finishing appliance of FIG. 1;

FIG. 4 is a block diagram of a finish control circuit of the food finishing appliance of FIG. 1;

FIG. 5 depicts an alternative embodiment of the control panel of the food finishing appliance of FIG. 1;

FIG. 6 is a lower left perspective view of the food finishing appliance of FIG. 1 with a divider partition;

FIG. 7 is a perspective view of the infrared burner of the food finishing appliance of FIG. 1;

FIG. 8 is a perspective view of the infrared burner of FIG. 7 with burner surface material removed; and

FIG. 9 is a perspective view of the food finishing appliance of FIG. 1 with front and side walls removed.

### DESCRIPTION OF THE PREFERRED EMBODIMENT

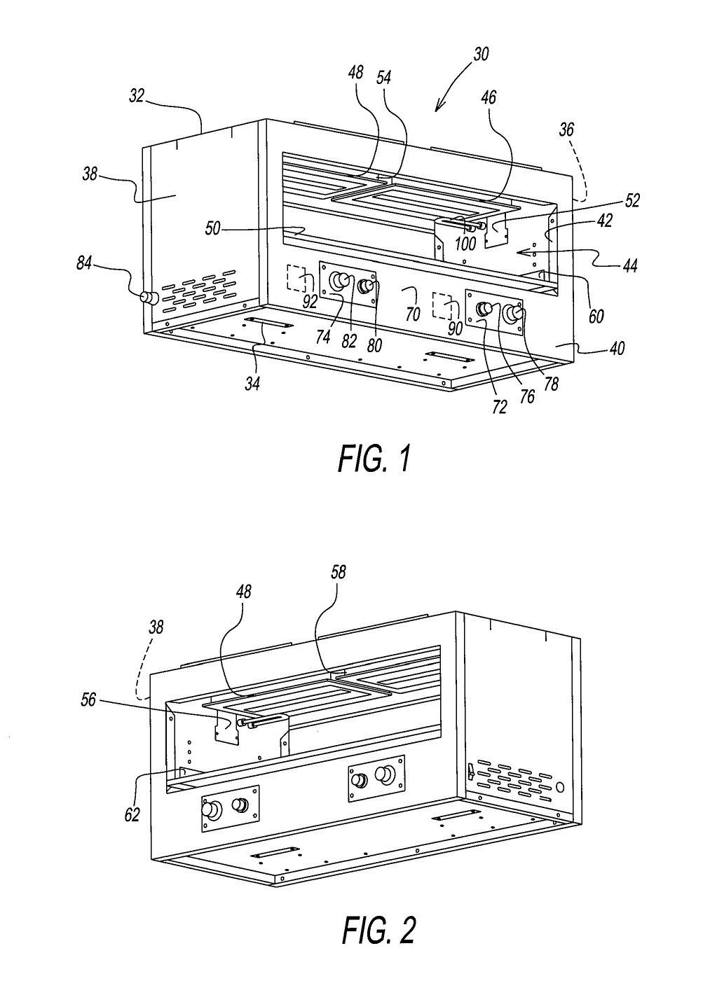

Referring to FIGS. 1-3 and 9, a food finishing appliance 30 of the present disclosure comprises a top wall 32, a bottom wall 34, side walls 36 and 38 and a front wall 40 arranged in a box like structure. Front wall 40 comprises an opening 42 to a food-finishing cavity 44. A heater 46, a heater 48 and a shelf 50 are disposed within food finishing cavity 44. Heaters 46 and 48 are located just below top wall 32 and shelf 50 is located below heaters 46 and 48 by a distance that allows a food product to be placed on shelf 50 for finishing.

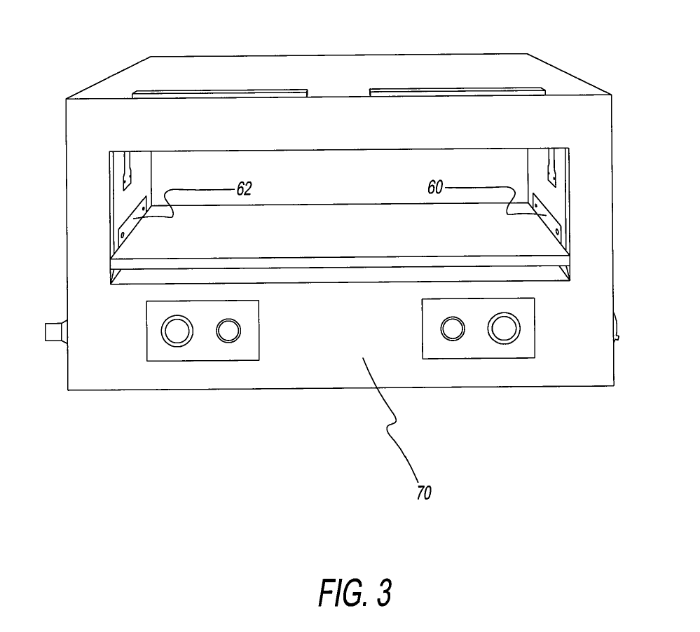

Heater 46 is supported by a mount 52 on side wall 36 and a mount 54 on top wall 32 as shown in FIG. 1. Heater 48 is supported by a mount 56 on side wall 38 and a mount 58 on top wall 32 as shown in FIG. 2. Shelf 50 is supported by mounts 60 and 62 on side walls 36 and 38 as shown in FIG. 3. Shelf 50 may be any suitable shelf, and though shown as a solid shelf, could also have perforations or be formed with wire or rods, as, e.g., a standard food rack.

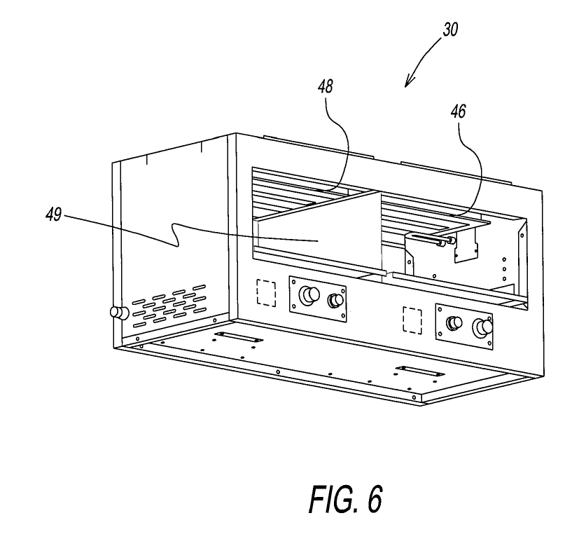

In the embodiment shown in FIGS. 1-3 and 9, heaters 46 and 48 are arranged side by side so as to provide two separate finishing areas so as to accommodate two separate food products for finishing. Referring also to FIG. 6, food finishing appliance 30 is shown with a divider partition 49 disposed in food finishing cavity 44 between heaters 46 and 48 to minimize heat transfer from one area to another. It will be apparent to those of skill in the art that the food finishing appliance of the present disclosure can have more or less than two heaters to provide a corresponding number of food product finishing areas.

A control panel 72 and a control panel 74 are mounted on front wall 40 below shelf 50 for the control of heaters 46 and 48, respectively. Control panel 72 carries a start button 76 and an interval timer adjustment selector 78 for heater 46. Control panel 74 carries a start button 80 and an interval timer adjustment selector 82 for heater 48. Control circuitry associated with control panels 72 and 74 is located in a compartment 70 that is disposed below shelf 50 within the interior of food finishing appliance 30. Other control components may also be disposed in compartment 70.

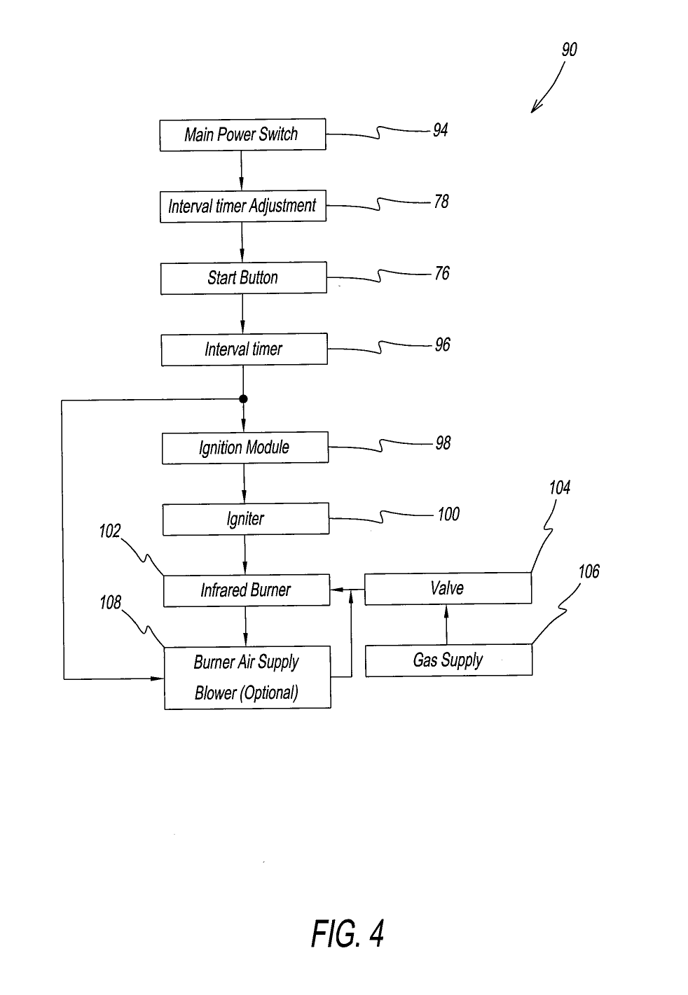

Heaters 46 and 48 are preferably gas burners, such as infrared burner 102, as shown in FIGS. 4 and 7-9, that comprise an infrared metal matrix burner surface. The burner surface can achieve surface temperatures in excess of 1500° F. without surface material breakage (unlike standard ceramic tile burners that are prone to fracture) or puncture. When shut off, the burner surface material cools quickly almost instantly stopping radiant heat.

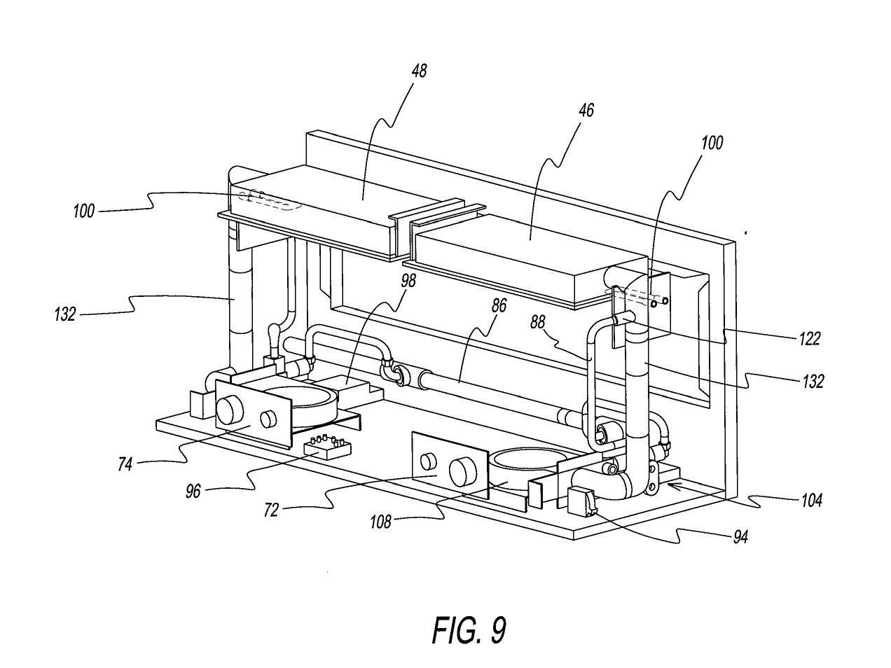

In operation, the operator places a food product to be finished in food finishing cavity 44 on shelf 50 below heater 46 or 48. The operator provides operator input by operating start button 76 and timer adjustment selector 78, which are connected in a finish control circuit 90. The operator uses timer adjustment selector 78 to select a finishing time interval. Then the operator activates start button 76 to provide a connection to electrical power or energy, which initiates a heating cycle by lighting the burner with an igniter 100 (FIGS. 1 and 9), which, for example, may be any suitable igniter, such as a pilot, a spark, a hot surface igniter, or the like. The burner heats up to an infrared state within five seconds and begins the finishing process. When the finishing time interval has ended or expired, finish control circuit 90 automatically shuts off the burner such that heating of the food product is stopped so as to prevent over cooking. A similar control circuit 92 is provided for controlling heater 48.

After activating start button 76, the operator can then walk away and do something else. After the finishing time has ended, the operator can then come back to food finishing appliance 30 to remove the food product, which has not been over cooked. Food finishing appliance 30 is completely off when food is not being finished, thereby saving energy and heat load to the kitchen.

Each heater 46 and 48 has an associated finish control circuit 90 and 92, respectively, which are substantially identical to one another. Therefore, only the finish control circuit 90 for heater 46 will be described. Referring to FIG. 4, finish control circuit 90 for heater 46 comprises a main power switch 94, interval timer adjustment selector 78, start button 76, an interval timer 96, an ignition module 98, an igniter 100, an infrared burner 102 and a valve 104. Infrared burner 102 is a preferred heater for and corresponds to heater 46. A gas supply 106 is connected to valve 104 via a gas fitting 84 (FIGS. 1 and 6) and a gas manifold 86 (FIG. 9). Valve 104 is connected to infrared burner 102 by a pipe or tube 88 (FIG. 9). Finish control circuit 90 controls valve 104 to supply gas from gas supply 106 to infrared burner 102 during a finish cycle. Valve 104 may be any suitable valve and preferably is a solenoid valve.

When main power switch 94 is closed, finish control circuit 90 is connected in circuit with alternating current (AC) power from a power grid or generator. When a food product to be finished is placed below infrared burner 102, the operator uses interval timer adjustment selector 78 to set or select a finish time interval (a finish time cycle) for finishing the food product. The operator then actuates start button 76 to connect interval timer 96 in circuit with the AC power via main switch 94 and interval timer adjustment 78. Interval timer 96 initiates the selected finish time interval by providing electrical energy to ignition module 98 and an optional burner air supply blower 108. Ignition module 98 provides electrical energy to open valve 104 to allow gas from gas supply 106 to flow to infrared burner 102. Ignition module 98 also provides electrical energy to igniter 100 to ignite the gas, which is entrained with ambient air. Burner air supply blower 108 can optionally be used to provide air under pressure for mixing with gas at infrared burner 102. Interval timer 96 at the end of the finish time interval removes electrical energy or power from optional air blower 108 and from ignition module 98, which in turn closes gas valve 104 and igniter 100.

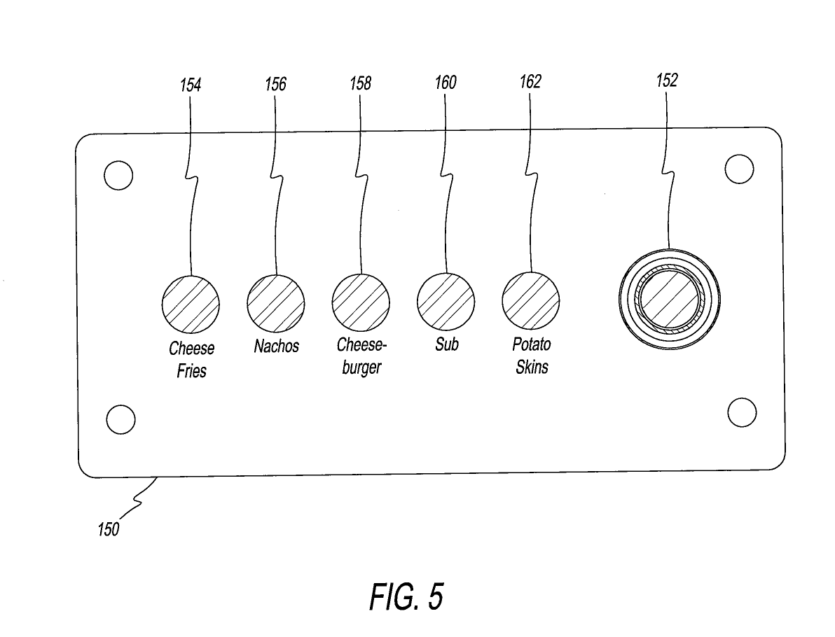

Interval timer adjustment selector 78 may comprise a variable resistor, such as a rheostat or potentiometer, a slider or other suitable selector such as the arrangement of food icons shown in FIG. 5 and described hereinafter. Interval timer 96 may be any suitable interval timer. For example, interval timer 96 may be interval timer module 4310 available from Artisan Controls Corporation of Randolph, N.J.

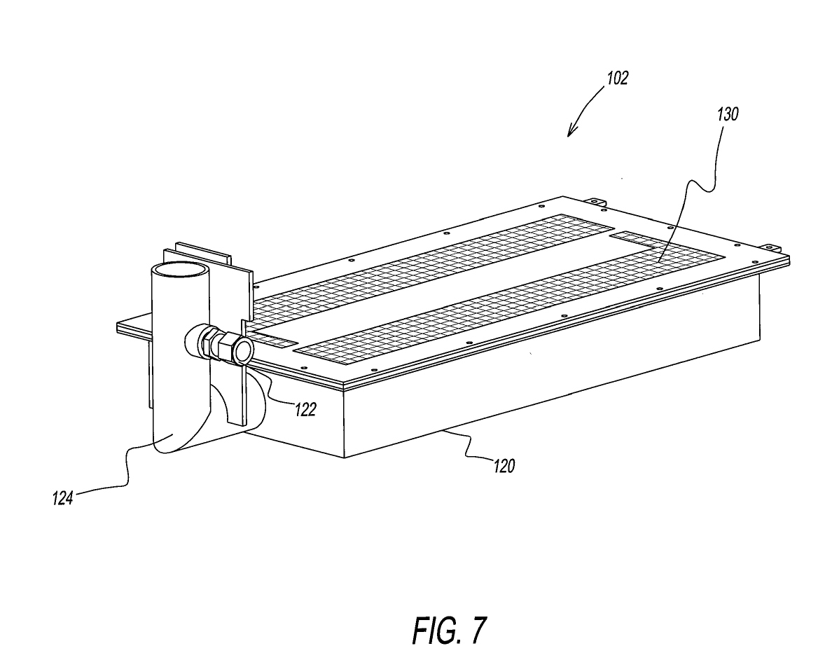

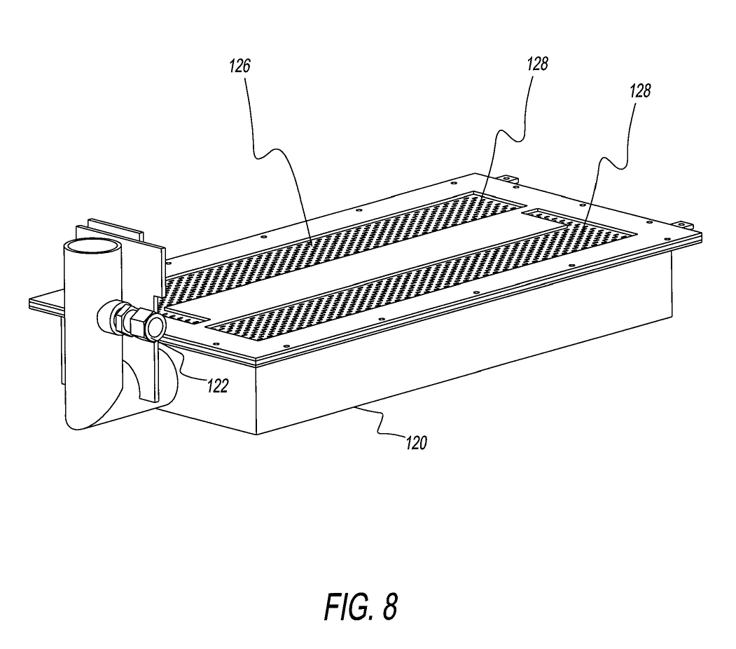

Referring to FIGS. 7, 8 and 9, infrared burner 102 comprises a plenum 120 that receives an air and gas mixture from valve 104 (see also FIG. 4) via a gas orifice fitting 122 that is joined to a combustion air tube 124. The air-gas mixture is then evenly distributed to a burner surface 130. Combustion air tube 124, for example, provides pressurized air from burner air supply blower 108 via an air hose 132 shown in FIG. 9. As shown in FIG. 8, plenum 120 is structured to hold a top sheet 126 that has a pattern of apertures 128 in fluid communication with the combustible air-gas mixture. Apertures 128 are preferably slots, but may have any other suitable shape. Top sheet 126 is covered with a metal fiber mat 130 shown in FIG. 7. Combustion takes place within metal fiber mat 130. Metal fiber mat 130 has a metal matrix surface that produces radiant infrared heat. Metal fiber mat 130, for example, is available from Micron Fiber-Tech of Debary, Fla. Some metal fiber mats come with a metallic backing and would not need metallic sheet 126.

In an alternate embodiment (not shown) infrared burner 102 is provided gas through gas orifice fitting 122 and entrains ambient air into plenum 120. The air-gas mixture is then evenly distributed to burner surface 130.

Referring to FIG. 5, an alternate embodiment of the control panel 150 for food finishing apparatus 30 comprises a start button 152 and separate icon buttons 154, 156, 158, 160 and 162 for food products cheese fries, notchoes, cheese burger, sub, and potato skins, respectively. Associated with each icon button is a time interval value, which when selected causes the time interval to be used by finish control circuit 90. These values can be represented by separate resistors for interval timer 96 described above. In an alternate embodiment, the values may be digital values that operate a counter to count up or down to establish the time interval for control of ignition module 98, igniter 100 and valve 104 and/or burner air supply blower 108. Alternatively, the digital values may address a lookup table that stores the time intervals. The food finishing appliance of the present disclosure is characterized by (a) a fast heat up infrared metal matrix burner surface that heats up to infrared within five seconds of lighting, burner surface temperatures in excess of 1500° F., (c) burner surface material that will not break (unlike standard ceramic tile burners that are prone to fracture) and cannot be punctured easily, (d) upon shut off, the burner surface material cools quickly so as to almost instantly stop radiant heat, (e) large energy saving over current cheese melters/finishers which need to maintain a minimum operating temperature whether or not in use, (f) pre-heat is unnecessary, (g) burner operation between heating cycles is unnecessary, (h) reduced heat load to the kitchen, (i) once time setting is selected and started, operator can walk away and do something else without over cooking food, (j) more comfortable to work around, when finishing, most of the radiant heat is going to the food and not to the operator, and when finished, no radiant heat is output to the kitchen, (k) can be mounted on a wall, used as a pass-through, or mounted over a range, and (l) extended life of the food finishing appliance (compared to current food finishing appliances)

The table set forth below gives exemplary finish cycles for various food products using food finishing appliance 30.

| | Product Temp Prior | Quantity/ | | |
|---|---|---|---|---|
| Product | to Cooking | Weight | | Time |
| Penne pasta | Pasta hot sauce, | Single | | 40 sec |
| with | hot cheese chilled | serving | | |
| marinara and | to 45 F. | | | |
| mozzarella | | | | |
| Chili cheese | | Family style | | 48 sec |
| fries | | platter | | |
| Nachos | Chips, pickled | Family style | | 50 sec |
| | jalapenos, scallions | platter | | |
| | and cilantro - | | | |
| | ambient, cheese 45 F. | | | |
| Texas Toast | Thawed, refrigerated | Two pieces | | 1 m:15 sec |
| | 41 F.-43 F. | | | |
| Garlic bread | Thawed refrigerated | 0.5 | loaf | 1 m:23 sec |
| | store bought | | | |
| Cheese burger | Burger 150 F. | 6 | oz burger | 30 sec |
| and bun | Cheese 41 F. | 1 | oz cheese | |
| | Bun ambient | 1 | bun | |
| Meatball sub | Meat balls 160 F. | 30 | sec | |
| | Held in food holding | | | |
| | cabinet with sauce | | | |
| | Cheese 41 F. | | | |

| | | | |
|---|---|---|---|
| Chicken parm | Fried 165 F. | 3 pieces on | 1 m:10 sec |
| | Sauce 150 F. | platter | |
| | Cheese 41 F. | | |

Alternate embodiments of the food finishing appliance of the present disclosure include, but are not limited to, a back wall and/or mounted to a wall, an adjustable shelf, one or more bottom burners, a digital programmable controller, a single burner unit with a smaller footprint, an adjustable shelf or rack, a divided food finishing cavity (e.g., a divider wall disposed between heaters 46 and 48 to divide food finishing cavity 44 into two separate units, a horizontal toaster/finisher configuration with conveyor and burner units off when no food product is present, and a horizontal conveyor with top and bottom burners and a control that when initiated lights the burners and then starts the conveyor, varies the conveyor speed relative to the internal condition in the unit (single runs vs. continuous cooking) and shuts off the burners and conveyor when the last product has completed a cooking event or cycle.

The present invention having been thus described with particular reference to the preferred forms thereof, it will be obvious that various changes and modifications may be made therein without departing from the spirit and scope of the present invention as defined in the appended claims.

What is claimed is:

1. A food finishing appliance for finishing a food product comprising:
a food finishing cavity comprising an opening through which said food product to be finished is inserted and removed;
an infrared gas heater disposed within said food finishing cavity; and
a control circuit that turns on said infrared gas heater and starts a finishing time interval and turns said infrared gas heater off when said finishing time interval ends, wherein said infrared gas heater consumes energy only during said finishing time interval.

2. The food finishing appliance of claim 1, further comprising a control panel that includes a finishing time interval selector that selects said finishing time interval and a start button that provides electrical energy that turns on said infrared gas heater and starts said finishing time interval.

3. The food finishing appliance of claim 1, wherein said control circuit connects and disconnects said infrared gas heater to one or more sources of energy as said finishing time interval starts and ends, respectively, so that said infrared gas heater consumes energy only during said finishing time interval.

4. The food finishing appliance of claim 3, wherein said energy is a member of the group consisting of: gas and gas and electrical.

5. The food finishing appliance of claim 4, wherein said infrared gas burner comprises a metal fiber mat within which combustion takes place.

6. The food finishing appliance of claim 5, wherein said infrared gas burner further comprises a plenum that is in fluid communication with said metal fiber mat.

7. The food finishing appliance of claim 6, wherein said plenum comprises a surface with a plurality of apertures to provide said fluid communication with said metal fiber mat.

8. The food finishing appliance of claim 6, wherein said metal fiber mat comprises a surface of said plenum.

9. The food finishing appliance of claim 1, wherein said food finishing cavity comprises a first food finishing area in which said opening and said infrared gas heater are disposed and a second food finishing area separate from said first food finishing area, and further comprising an additional opening, an additional infrared gas heater disposed in said second food finishing area, and an additional control circuit to control the finishing of an additional food product in said second area.

10. A method for finishing a food product comprising:
providing a food finishing cavity comprising an opening through which said food product to be finished is inserted and removed;
disposing an infrared gas heater within said food finishing cavity; and
providing a control circuit that turns on said infrared gas heater and starts a finishing time interval and turns said infrared gas heater off when said finishing time interval ends, wherein said infrared gas heater consumes energy only during said finishing time interval.

11. The method of claim 10 further comprising: providing a control panel that includes a finishing time interval selector that selects said finishing time interval and a start button that provides a connection to electrical energy that turns on said infrared gas heater and starts said finishing time interval.

12. The method of claim 10, wherein said control circuit connects and disconnects said infrared gas heater to one or more sources of energy as said finishing time interval starts and ends, respectively, so that said infrared gas heater consumes energy only during said finishing time interval.

13. The method of claim 12, wherein said energy is a member of the group consisting of: gas and gas and electrical.

14. The method of claim 13, wherein said infrared gas burner comprises a metal fiber mat within which combustion takes place.

15. The method of claim 14, wherein said infrared gas burner further comprises a plenum that is in fluid communication with said metal fiber mat.

16. The method of claim 15, wherein said plenum comprises a surface with a plurality of apertures to provide said fluid communication with said metal fiber mat.

17. The method of claim 15, wherein said metal fiber mat comprises a surface of said plenum.

18. The method of claim 10, wherein said food finishing cavity comprises a first food finishing area in which said opening and said infrared gas heater are disposed and a second food finishing area separate from said first food finishing area, and further comprising an additional opening, an additional infrared gas heater disposed in said second food finishing area, and an additional control circuit to control the finishing of an additional food product in said second area.
